(19) United States
(12) Patent Application Publication
(10) Pub. No.: US 2009/0090228 A1
(43) Pub. Date: Apr. 9, 2009

(54) METHOD AND DEVICE FOR ALLOCATING PACKAGING MATERIAL

(75) Inventors: Frank Weller, Verden (DE); Peter Knodel, Oyten (DE); Heiko Walter, Intschede-Reer (DE)

Correspondence Address: WOOD, HERRON & EVANS, LLP, 2700 CAREW TOWER, 441 VINE STREET, CINCINNATI, OH, 45202, US

(73) Assignee: VEMAG Maschinenbau GmbH, Verden/Aller (DE)

(21) Appl. No.: 12/245,244

(22) Filed: Oct. 3, 2008

(30) Foreign Application Priority Data
Oct. 5, 2007 (DE) 102007048047.6

(51) Int. Cl. B26D 7/00

(52) U.S. Cl. 83/27; 83/102

(57) ABSTRACT

The present invention relates to a method for allocating packaging material, in particular paper, to apportioned foods, having these steps: delivery of portions of a food onto a first conveyor belt, delivery and allocation of packaging material to the portions, characterized in that the packaging material is fed to the first conveyor belt and allocated to the portions without first being cut, and that the packaging material is then cut between two portions. The invention also relates to a corresponding device.

The present invention relates to a method for allocating packaging material, in particular paper, to apportioned foods, having these steps: delivery of portions of a food onto a first conveyor belt, and delivery and allocation of packaging material to the portions. The invention also relates to a device for allocating packaging material, in particular paper, to apportioned foods, with a conveyor belt to receive and convey portions of a food, and means of conveying and allocating packaging material to the portions.

In growing measure, producers of foods are incorporating advanced processing steps into their production chain, in order to meet the demand of the retail trade for foods that are ready to serve or that are prepared for final processing. This also includes in particular dividing foods into portions and packaging the portions in a user-friendly manner. In the meat processing industry in particular, ground meat for example for preparing hamburgers or similar products is subdivided into individual portions (patties) already during production.

To enable the consumer to remove the individual portions without damage and begin final processing, the individual portions must be easy to separate from each other in their packaging.

One established method for packaging the portions separably is to place packaging material—in particular plastic or paper film—between the individual portions, to prevent the portions from sticking to each other. Known devices carry out this working step, in which packaging material is divided into individual segments, and these individual segments are then slid under already-formed food portions or the food portions are slid onto them.

This timed underlaying of the otherwise already finished products requires exact synchronization of the transport of the individual sheets with the transport of the product portions. That brings with it the disadvantage that devices of the type named at the beginning are of complex design, are expensive to purchase and maintain, and are correspondingly slow.

The object of the present invention is therefore to specify a method and a device for allocating packaging material, in particular paper, to apportioned foods, which reduce the cost outlay for automated packaging operations of the forenamed type.

The present invention solves the problem by means of a method of the type named at the beginning in which the packaging material is fed to the first conveyor and allocated to the portions without first being divided, and the packaging material is then cut off between two portions.

A particular advantage of the method according to the invention is that the packaging can be delivered to the first conveyor belt continuously, and synchronization of the packaging material delivery is not necessary. Drive means such as intermittently driven roller pairs which are employed in previously known devices to pre-separate and accelerate the packaging material can be dispensed with. Allocating the food portions to uncut packaging material also greatly increases the flexibility of the method according to the invention with regard to the type and size of the portions being processed.

The method according to the invention is further refined by underlaying the portions with packaging material, in particular paper, which is taken from a roll and transported as an endless strip, and which is cut through using cutting means. Although in principle various types of allocation of packaging material to the food portions are possible, for example covering the portions with packaging material or wrapping the portions in it, laying packaging materials under the portions appears to be a form of execution that is technically simple and attainable with little expense for components. The preferred cutting means is an electrically driven parting knife, which is situated above the conveyor belts during operation, although situating it to the side or beneath the conveyor belts can be considered in view of spatial circumstances or the design of a system with which the method according to the invention is operated. Other cutting means using methods such as water-jet cutting or laser cutting may be advantageous, depending on the application and the packaging material.

In another exemplary embodiment of the method according to the invention, the portions with packaging material under them are transported away for further processing by a second conveyor belt. Other processing steps which may follow after the packaging material has been laid under the food portions relate for example to coloring, shaping, cooling or heating the portions. Other packaging steps can also follow, such as for example stacking or heat-sealing.

In another embodiment of the invention, the portions are dispensed onto the packaging material being conveyed by the first conveyor belt, for example with the aid of a filling machine. Since the individual portions thus already have packaging material under them at the beginning of the processing procedure, the further handling of the portions for subsequent processing steps is greatly simplified.

According to an advantageous refinement of the method according to the invention, the cutting is performed by the cutting means at a transition section between the first and a second conveyor belt. The gap remaining between the two conveyor belts can be used in this way for the cutting means to pass between the two conveyor belts. In the event that the cutting means are constituted by a parting knife, the cutting process can thus occur without the first or second conveyor belt being influenced by the cutting means, which otherwise could result in damage or wear to the conveyor belts. The size of the gap between the two conveyor belts is chosen according to the cutting means to be used, as well as the portion sizes and the transport speeds of the conveyor belts normally expected.

In a preferred embodiment of the present invention, in one process step the portions are pressed by a pressing belt.

According to another embodiment of the present invention, the portions are pressed between the pressing belt and the second conveyor belt when the packaging material has already been placed under the portions. Since the pressing does not occur until the packaging material is under the portions, the portions are prevented from sticking to the second conveyor belt, which could be disadvantageous with regard to further processing steps, or in the worst case could result in damage to the portions when removing the portions from the second conveyor belt.

In a refinement of the method according to the invention, the cutting of the packaging material is triggered by sensors which recognize the sections between two portions. Non-contact sensors, in particular optical sensors, are regarded as especially advantageous sensors, since they do not influence the food in any way. Because of the sensor-controlled triggering of the cutting process, it is also not necessary to provide a mechanical coupling between the transporting of the packaging material or the portions and the cutting means, which greatly simplifies the design of a device for carrying out the method according to the invention.

In another embodiment of the present invention, after being placed on the packaging material the portions do not completely cover the area of the allocated packaging material. In this embodiment, the size of the packaging material can be defined in advance so that future changes in the shape of the portions which result from other processing steps, such as for example portion pressing or dough baking, nevertheless do not result in the proportions extending beyond the packaging material. If it should be desired for example that the portions extend beyond the edges of the packaging material, for example if the packaging material is not to be visible between the individual portions, this can be taken into account by appropriate dimensioning of the packaging material relative to the portions and/or vice versa.

In one preferred embodiment of the method according to the invention, an interval remains in the transport direction between two adjacent portions, and perpendicular to the transport direction an interval remains between the edge of a portion and the side edge of the packaging material, which are influenced by one or more of the following influencing variables: transport speed of the first conveyor belt, transport speed of the second conveyor belt, transport speed of the pressing belt, smallest interval between the surface of the pressing belt and the second conveyor belt, width of the packaging material being transported, and position of the cutting process between two portions. The transport speed of the first conveyor belt influences the interval between two adjacent portions after they have been placed on the first conveyor belt. The transport speed of the second conveyor belt influences the interval between two adjacent portions before the pressing procedure. The transport speed of the pressing belt influences the shape which the portions assume as a result of the pressing. A relative speed between the pressing belt and the conveyor belt, between which the portions are pressed, results in a shearing of the portion during the pressing, which causes it to assume an elongated shape in the transport direction. Depending on whether the transport speed of the pressing belt is faster or slower than the speed of the second conveyor belt, the portions are more likely to be deformed in the direction of a front side edge or in the direction of a rear side edge of the packaging material, which has in the meantime been cut. In this way, the final spacing and/or overhang between the pressed portion and the packaging material can be influenced. The smallest interval between the surface of the pressing belt and the second conveyor belt has a decisive influence on the thickness of the food after the pressing. The smaller the distance, the further the portion extends over the packaging material in the transport direction and perpendicular to the transport direction after the pressing. The width of the transported packaging material and the portion [Translator's note: So stated in the German original; position of the cutting process is probably intended.] of the cutting process between two portions determines how large the lateral spaces are between the portion and the side edge of the cut packaging material before the pressing. In an advantageous refinement of the method according to the invention, one or more of the influencing variables are modified manually or by a control unit in order to set the distance remaining after the pressing between the pressed portion and the side edges of the cut packaging material. In this way the greatest possible flexibility of the method is ensured for various foods and applications.

The present invention also solves the problem by means of a device of the type named at the beginning, in which the means for transporting and for delivering the packaging material are situated and designed so that the packaging material can be fed to the conveyor belt and allocated to the portions in the uncut state, and so that the device has cutting means that are designed to perform a cutting process between two portions. With regard to the action and benefits we refer to the explanations above.

In one advantageous embodiment of the method according to the invention, the means of transporting and feeding the packaging material have a roll to receive and dispense an endless strip of packaging material which is allocated to the first conveyor belt in such a way that transported packaging material can be placed under the portions. Placing packaging material under the portions is a technically simple possibility of allocating packaging material to the portions. Furthermore, through suitable design with regard to the arrangement of the first conveyor belt and of the packaging material, the packaging material can be pulled along directly by the first conveyor belt, so that no additional drive is necessary for removing the packaging material from the roll. This is of particular benefit with regard to reducing the components of the device.

According to another embodiment of the present invention, the device has a second conveyor belt to transport the allocated portions away for further processing. Advantageously, the second conveyor belt is spaced and situated with regard to the first conveyor belt so that the portions with packaging material under them travel from the first conveyor belt to the second conveyor belt without any danger that the portions will end up between the two conveyor belts. This is usually ensured by the fact that the second conveyor belt is essentially situated slightly below the first conveyor belt.

In one preferred embodiment of the device according to the invention the cutting means are situated relative to the first and second conveyor belts so that the cutting of the packaging material takes place between the first and the second conveyor belt. Choosing this arrangement of the cutting means ensures that the packaging material can be cut through without the cutting means damaging the first or second conveyor belt. An especially advantageous arrangement of the cutting means is consequently the arrangement vertically above the gap between the first and second conveyor belts. The gap between the two conveyor belts must be dimensioned here so that the cutting means, with allowance for appropriate freedom of movement, do not touch either the first or the second conveyor belt when carrying out the cutting process.

In another embodiment of the device according to the invention, the device has a pressing belt that is arranged and designed to press portions in the device. It can be especially advantageous here to provide the pressing belt with a surface texture that imprints a pattern on the portion. Furthermore, the pressing belt should be chosen from a material to which as little as possible of the pressed food will stick.

In another embodiment of the present invention the pressing belt operates together with the second conveyor belt. Because of the prior placement of packaging material under the portions there can be no adhesion between the portions and the second conveyor belt, leading to an improvement in the pressing procedure and thus in the processing quality of the device according to the invention.

In an advantageous embodiment of the device according to the invention, the device has sensors which are designed to detect the section between two adjacent portions on the first conveyor belt. The interval between two adjacent portions corresponds substantially to the sum of the distance between a portion and its front side edge and the distance of the portion from the rear side edge of the packaging material allocated to it and cut off. The exact position of the cutting process within this section accordingly defines the size of the ratio of these two distances to each other, which in turn influences the overhang and/or space between the portion and the packaging material before and/or after the pressing procedure.

In another embodiment of the device according to the invention, the sensors are designed to trigger the cutting process of the cutting means. By specifically selecting the delay which occurs between the detection of an end of a portion and the actual triggering of the cutting process, it is possible to determine the exact position of the cutting process and thus of the side edges of the cut-off parts of the packaging material. A short delay causes a smaller distance between the portion and a rear side edge of the packaging material, a longer delay accordingly causes lengthening of the distance between the portion and the rear side edge, accompanied by shortening of the distance between the portion and the front side edge of the cut-off packaging material.

According to a refinement of the device according to the invention, one or more of the influencing variables can be adjusted and/or regulated by means of a control unit: transport speed of the first conveyor belt, transport speed of the second conveyor belt, transport speed of the pressing belt, smallest interval between the surface of the pressing belt and the second conveyor belt, width of the packaging material being transported, and position of the cutting process between two portions. In addition to the necessary electronics, such a control unit preferably includes operating elements which are situated so that the user of the device can influence the above-named parameters individually, or select preprogrammed combinations of parameters which are stored in the control unit for certain applications.

According to an advantageous embodiment of the present invention, the device also has an input line for connecting a filling machine, through which foods fed in from the filling machine can be transported to a shaping nozzle to shape the portions. Through appropriate design of the shaping nozzle, the raw shape of the portions to be processed by the device is influenced decisively. To produce patties for hamburgers, an essentially cylindrical orifice section of the shaping nozzle has proven to be advantageous. But other orifice cross sections are also conceivable for other applications.

According to another embodiment, the device of the present invention has second cutting means, to separate the individual portions of foods. The second cutting means are preferably situated at one end of the input line, and carry out the function of subdividing the mass of food continuously delivered by the input line into individual portions. This is also implemented in a technically simple manner by a parting knife.

In another embodiment, in the device according to the invention the latter has a support ring situated adjacent to the shaping nozzle to guide the cut-off portions in the direction of the packaging material situated on the first conveyor belt. The cross-sectional opening of the support ring preferably corresponds essentially to the shape of the orifice cross section of the shaping nozzle. The support ring serves the purpose of guiding the cut-off portions over at least a short distance, so that the portions can be loaded onto the first conveyor belt uniformly and reliably.

The device and the method according to the invention present themselves in an advantageous manner in a system for processing foods, in particular ground meat, comprising a filling machine and a device according to one of claims 12 through 24, designed in particular to carry out a method according to one of claims 1 through 11.

The invention will now be described in greater detail on the basis of exemplary embodiments, with reference to the accompanying figures. The figures show the following:

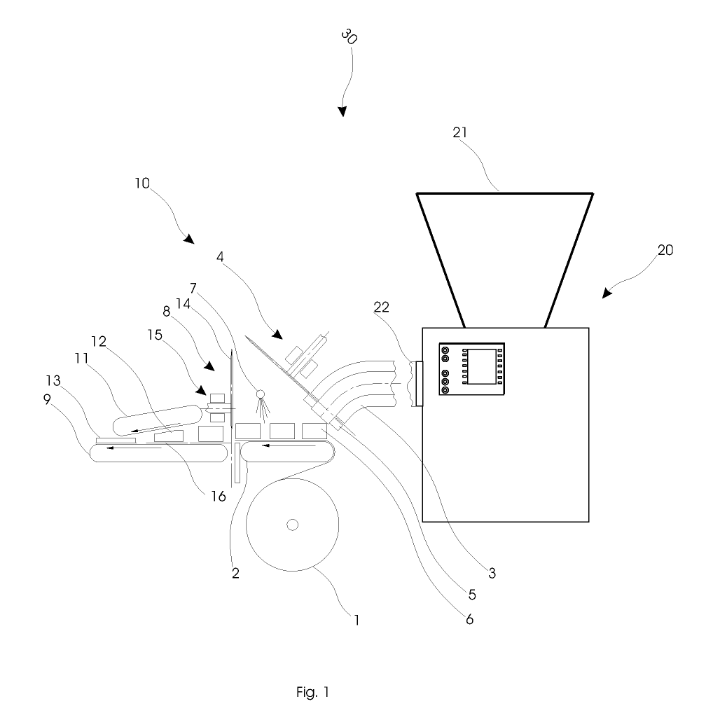

FIG. 1 a schematic depiction of a side view of a system 30 according to the invention for processing foods,

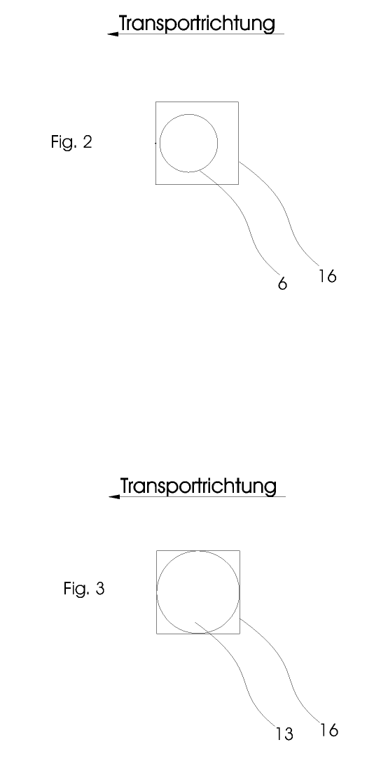

FIG. 2 a schematic depiction of a portion 6 in top view, and

FIG. 3 a schematic depiction of a portion 13 in top view.

The system 30 depicted in FIG. 1 for processing foods includes a device 10, to which a known filling machine 20 is connected.

Packaging material is fed from an endless roll 1 to a first conveyor belt 2 and is transported by the latter. The arrow depicted within first conveyor belt 2 indicates the direction of circulation of first conveyor belt 2 during normal operation. A food divided into portions 6, which is fed from a loading funnel 21 of filling machine 20 through an input line 22 to a shaping nozzle 3, is fed to first conveyor belt 2. At one end of shaping nozzle 3 cutting means 4 with a parting knife are situated, which cut off individual portions 6 from the mass of food present in shaping nozzle 3. These cut-off portions 6 are placed on the packaging material, which is on the first conveyor belt 2. The portions 6 are spaced at a distance from a respective adjacent portion 6, and are transported on first conveyor belt 2 in the indicated transport direction. In the depicted exemplary embodiment, sensors 7 which recognize the sections between two adjacent portions 6 are situated above first conveyor belt 2. Triggered by the sensors 7, cutting means 8 cut the packaging material apart between the first conveyor belt and a second conveyor belt 9.

The embodiment of the present invention depicted in FIG. 1 has a parting knife 14 connected to a rotary drive 15. Parting knife 14 cuts through the packaging material in a rotary downward motion, and returns following the cutting motion to its starting position, where it waits until a next cutting process needs to be performed. A section 16 of cut-off packaging material is allocated to the portions 6 by the cutting process. The portions 6 are fed to the second conveyor belt 9 together with the assigned packaging material 16.

Second conveyor belt 9 carries the portions 6 with the assigned packaging material 16 to a pressing belt 11. In the depicted embodiment, to better guide the portion 6 the pressing belt is situated at an angle that comes to a point in the transport direction of second conveyor belt 9 and in the transport direction of pressing belt 11, and that has a minimum interval between pressing belt 11 and second conveyor belt 9 at a rear end of pressing belt 11, viewed in the transport direction of second conveyor belt 9. FIG. 1 also depicts a portion 12, which is partially pressed. Also depicted is a portion 13, which is essentially completely pressed. The volume of portions 12 and 13 corresponds to the volume of portion 6, although the surface of the packaging material covered by portion 13 is considerably greater than the surface that is covered by portion 6.

The coverage of the surface of the packaging material by portions 6 and 13 is depicted schematically in FIGS. 2 and 3. FIG. 2 shows a portion 6 which is situated on a section 16 of the packaging material, and is at a distance from the respective side edges of section 16. In the depicted embodiment portion 6 is centered in the transport direction on section 16 of the divided packaging material. The distances of portion 6 from the front and rear side edges of section 16 of the packaging material are not the same. The distance to the side edge lying in the transport direction is smaller than the distance to the side edge lying opposite the transport direction. The ratio of these distances to each other can be influenced by a suitably chosen delay between the recognition of the section between two portions 6 by the sensors 7 and the triggering of the cutting process by cutting means 8, in such a way that after execution of the pressing procedure the state depicted in FIG. 3 results. FIG. 3 depicts a pressed portion 13 which is situated on section 16 of the packaging material. Portion 6 has been reduced to a lesser height by the pressing procedure, but has spread out on all sides. Through appropriate adjustment of the distances from portion 6 to the side edges of section 16 of the packaging material, of the smallest distance between pressing belt 11 and second conveyor belt 9, and of the speeds of second conveyor belt 9 and pressing belt 11, the pressed portion essentially no longer has any distance to the side edges of section 16 of the packaging material.

1. A method for allocating packaging material, to apportioned foods, comprising:
delivering portions of a food onto a first conveyor belt,
delivering and allocating the delivery and allocation of packaging material to the portions by feeding characterized in that the packaging material to the first conveyor belt and allocating the packaging material to the portions without cutting the packaging material beforehand, and
cutting the packaging material between two portions after delivering and allocating the packaging material.

2. The method according to claim 1, further comprising:
underlaying the portions with the packaging material taken from a roll and transported as an endless strip, and
cutting through the packaging material using a cutting mechanism.

3. The method according to claim 1, further comprising:
transporting the portions and allocated packaging material away with a second conveyor belt for further processing.

4. The method according to claim 1, wherein the portions are placed on the packaging material being transported by the first conveyor belt.

5. The method according to claim 1, wherein
the cutting is performed by a cutting mechanism at a transition section between the first conveyor belt and a second conveyor belt.

6. The method according to claim 1, further comprising:
pressing the portions by means of a pressing belt.

7. The method according to claim 6, further comprising:
pressing the portions between the pressing belt and a second conveyor belt after placing the packaging material under the portions.

8. The method according to claim 1, wherein:
the cutting of the packaging material is triggered by sensors which recognize the sections between two portions.

9. The method according to claim 1, further comprising:
placing the portions on the packaging material such that the portions do not completely cover the area of the allocated packaging material.

10. The method according to claim 9, wherein
a first interval remains in the transport direction between two adjacent portions, and perpendicular to the transport direction and a second interval remains between an edge of a portion and a side edge of the packaging material, the intervals being influenced by one or more of the following influencing variables:
the transport speed of the first conveyor belt,
the apportioning speed when producing the portions,
the smallest interval between the surface of a pressing belt and a second conveyor belt,
the width of the packaging material being transported, and
the position of a cutting mechanism for the cutting step between two portions.

11. The method according to claim 10, wherein:
one or more of the influencing variables are modified manually or by a control unit in order to set a distance remaining between one of the portions that has been pressed and side edges of the cut packaging material.

12. A device for allocating packaging material, to apportioned foods, comprising:
a conveyor belt to receive and transport portions of a food,
a mechanism operative to transport and allocate packaging material to the portions, said mechanism arranged and designed so that the packaging material can be fed to the conveyor belt and allocated to the portions in an uncut state, and
a cutting mechanism configured to carry out a cutting process between two portions.

13. The device according to claim 12, wherein:
the mechanism operative to means for transport and allocate the packaging material includes a roll to receive and dispense an endless strip of packaging material which is allocated to the first conveyor belt in such a way that transported packaging material can be placed under the portions.

14. The device according to claim 12, further comprising:
a second conveyor belt (9) to transport the allocated portions away for further processing.

15. The device according to claim 14, wherein
the cutting mechanism is situated relative to the first and the second conveyor belts so that the cutting of the packaging material takes place between the first and the second conveyor belts.

16. The device according to claim 12, further comprising:
a pressing belt configured for pressing the portions.

17. The device according to claim 16, wherein:
the pressing belt operates together with a second conveyor belt.

18. The device according to claim 12, further comprising:
sensors designed to detect the respective sections between adjacent portions on the first conveyor belt.

19. The device according to claim 18, wherein
the sensors are designed to trigger cutting performed by the cutting mechanism.

20. The device according to claim 12, wherein
one or more of the following influencing variables can be adjusted and/or regulated by means of a control unit:
transport speed of the first conveyor belt,
transport speed of a second conveyor belt,
transport speed of a pressing belt,
the smallest interval between a surface of the pressing belt and the second conveyor belt,
the length of the packaging material being transported, and
the position of the cutting mechanism between two portions.

21. The device according to claim 12, further comprising:
an input line for connecting a filling machine, through which food delivered from the filling machine can be transported to a shaping nozzle to shape the portions.

22. The device according to claim 21, further comprising:
a second cutting mechanism situated upstream from the first conveyor belt, to separate the respective portions of foods.

23. The device according to claim 22, further comprising:
a support ring situated adjacent to the shaping nozzle to guide a cut-off portion in the direction of the packaging material situated on the first conveyor belt.

24. A system for processing apportioned foods, comprising:
a filling machine,
a conveyor belt to receive and transport portions of a food from the filling machine,
a mechanism operative to transport and allocate packaging material to the portions, said mechanism arranged and designed so that the packaging material can be fed to the conveyor belt and allocated to the portions in an uncut state, and
a cutting mechanism configured to carry out a cutting process between two portions.
